(19) United States
(12) Patent Application Publication
(10) Pub. No.: US 2014/0376462 A1
(43) Pub. Date: Dec. 25, 2014

(54) METHOD FOR RESOURCE ACCESS IN WIRELESS COMMUNICATION NETWORK

(71) Applicant: Electronics and Telecommunications Research Institute, Daejeon (KR)

(72) Inventors: Seokki KIM, Daejeon (KR); Soojung JUNG, Daejeon (KR); Seungkwon CHO, Daejeon (KR); Hyung Jin KIM, Daejeon (KR); Hyun LEE, Daejeon (KR); Sung Cheol CHANG, Daejeon (KR); DongSeung KWON, Daejeon (KR)

(73) Assignee: Electronics and Telecommunications Research Institute, Daejeon (KR)

(21) Appl. No.: 14/309,315

(22) Filed: Jun. 19, 2014

(30) Foreign Application Priority Data
Jun. 20, 2013 (KR) 10-2013-0071073
Jun. 11, 2014 (KR) 10-2014-0071053

(51) Int. Cl. H04W 74/08; H04W 72/04

(52) U.S. Cl. CPC H04W 74/0808; H04W 72/0446
USPC 370/329

(57) ABSTRACT

Disclosed herein is a method for resource access, including: selecting at least one data sub-frame among a plurality of sub-frames included in a frame; transmitting the data from the data sub-frame; and transmitting a blocking signal from a previous sub-frame of the data sub-frame.

### CROSS-REFERENCE TO RELATED APPLICATION

This application claims priority to and the benefit of Korean Patent Application Nos. 10-2013-0071073 and 10-2014-0071053 filed in the Korean Intellectual Property Office on Jun. 20, 2013 and Jun. 11, 2014, the entire contents of which are incorporated herein by reference.

### BACKGROUND OF THE INVENTION

(a) Field of the Invention

The present invention relates to a method for radio resource access among a plurality of heterogeneous terminals in a wireless distributed communication network.

(b) Description of the Related Art

Recently, research into a direct communication (device to device, D2D) network for an application service based on adjacency has progressed, and various technologies to support the direct communication have been proposed. As a representative technology supporting the direct communication in a wireless distributed communication network, there are FlashLinQ, IEEE 802.11 WiFi direct communication, and IEEE 802.15.8 peer awareness communication (PAC). Among the direct communication technologies, in the case of considering an operation in an unlicensed frequency bandwidth (unlicensed band), a carrier sense multiple access (CSMA) scheme may be used for multiple access among a plurality of heterogeneous devices. IEEE 802.11 WiFi is one of representative standard technologies using the CSMA scheme in the unlicensed band.

In the CSMA scheme, each terminal utilizes carrier sensing (CS) to detect a usage state of the radio resource for data transmission, and attempts the data transmission to the other terminal when it is determined that the radio resource is in an idle state. The CSMA scheme is technically simple and has a merit of being capable of easily achieving a mutual coexistence among the heterogeneous devices. Therefore, the CSMA scheme is a multiple access scheme that is most widely used in wireless communication technology using the unlicensed frequency bandwidth.

However, since the CSMA scheme has a structure in which all the devices adjacent to one another compete for the data transmission, when the number of devices using the unlicensed frequency bandwidth increases, there are drawbacks that collision between the transmission data increases, data transmission delay may become longer, and efficiency of the radio resource rapidly decreases. In order to solve the problem that the efficiency of the radio resource is deteriorated, in the IEEE 802.15.8 PAC, a PAC frame having a fixed length and a plurality of sub-frames for the multiple access of the PAC devices via a distributed synchronization of a PAC device (PD) is configured. Further, in the IEEE 802.15.8 PAC, a method of increasing the efficiency of the radio resource by eliminating the collision between the data transmitted from the plurality of PAC devices via a distributed scheduling method has been researched.

However, when the sub-frame that is not used presents in the sub-frames that are present within a single frame, the heterogeneous device using the CSMA scheme determines that the radio resource is in the idle state to start the data transmission. In this case, the data transmitted from the device using the CSMA scheme may collide with data transmitted from the PAC device.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for radio resource access so that data do not collide among heterogeneous devices using a carrier sense multiple access (CSMA) scheme.

An exemplary embodiment of the present invention provides a method for resource access of a wireless device. The method for resource access may include: selecting at least one data sub-frame among a plurality of sub-frames included in a frame; transmitting the data from the data sub-frame; and transmitting a blocking signal from a previous sub-frame of the data sub-frame.

The transmitting of the blocking signal may include transmitting the blocking signal from all the previous sub-frames of the data sub-frame among the plurality of sub-frames.

The transmitting of the blocking signal may include transmitting the blocking signal using at least one sub-carrier.

The sub-frame may include a data region in which the data are transmitted and a blocking region in which the blocking signals are transmitted.

The sub-frame may further include a guard band so as to divide the data region and the blocking region.

The selecting may include selecting the at least one data sub-frame according to a carrier sense multiple access (CSMA) scheme.

Another exemplary embodiment of the present invention provides a method for resource access of a wireless device. The method for resource access may include, in a frame including a plurality of sub-frames, selecting a first resource unit among a plurality of resource units included in the each of a plurality of sub-frames, transmitting data from the first resource unit, and transmitting a blocking signal from a first sub-frame including the first resource unit among a plurality of sub-frames.

The method may further include, in next frame of the frame, selecting a second resource unit based on a position at the frame of the first resource unit, and transmitting the data from the second resource unit.

The selecting of the second resource unit may include, when the number of the plurality of resource units is n², configuring the first resource unit so as to correspond to a first component among components of n×n matrix, determining a position of a second component among the components of the n×n matrix based on the position of the first component, and determining a position of the second resource unit based on the position of the second component.

The determining of the position of the second component may include determining a row of the second component through circulation augmentation of a row number of the first component, and determining a column of the second component in the sum of the row number and the column number of the first component.

In the determining of the position of the second component, when the position of a first component is iₚᵣₑᵥᵢₒᵤₛ and jₚᵣₑᵥᵢₒᵤₛ and the position of the second component is iₙₑₓₜ and jₙₑₓₜ, the position of the second component may be determined according to the following equation. DeletedTexts

The selecting of the second resource unit may include, when the number of the plurality of resource units is n×m, configuring the first resource unit so as to correspond to a first component among components of an n×m matrix, determining a position of a second component among the components of the n×m matrix based on the position of the first component, and determining a position of the second resource unit based on the position of the second component.

The determining of the position of the second component may include determining a row of the second component through circulation augmentation of a row number of the first component, and determining a column of the second component in the sum of the row number and the column number of the first component.

In the determining of the position of the second component, when the position of first component is iₚᵣₑᵥᵢₒᵤₛ and jₚᵣₑᵥᵢₒᵤₛ and the position of the second component is iₙₑₓₜ and jₙₑₓₜ, the position of the second component may be determined according to the following equation.

iₙₑₓₜ=iₚᵣₑᵥᵢₒᵤₛ+1, if i+1≦n

iₚᵣₑᵥᵢₒᵤₛ+1−n, if i+1>n (i=1˜n)

jₙₑₓₜ=iₚᵣₑᵥᵢₒᵤₛ+jₚᵣₑᵥᵢₒᵤₛ, if i+j≦m

iₚᵣₑᵥᵢₒᵤₛ+jₚᵣₑᵥᵢₒᵤₛ−m, if i+j>m (j=1˜m)

The transmitting of the blocking signal may include transmitting the blocking signal using at least one sub-carrier.

The plurality of sub-frames may include a data region in which the data are transmitted and a blocking region in which the blocking signals are transmitted.

The plurality of sub-frames further may include a guard band so as to divide the data region and the blocking region.

The selecting may include selecting the first resource unit among the plurality of resource units according to a carrier sense multiple access (CSMA) scheme.

According to an exemplary embodiment of the present invention, each wireless device using the CSMA scheme transmits the signal from the sub-frame transmitting the data to allow the heterogeneous wireless device not occupy the radio resource, thereby making it possible to prevent the data collision.

### BRIEF DESCRIPTION OF THE DRAWINGS

FIG. 1 is a drawing showing a network in which heterogeneous devices are mixed.

FIGS. 2 (A) and (B) are drawings showing frames transmitted by a peer awareness communication (PAC) device and WiFi device.

FIGS. 3 (A) and (B) are drawings showing frames transmitted by PAC device and WiFi device according to an exemplary embodiment of the present invention.

FIG. 4 is a drawing showing a PAC sub-frame according to an exemplary embodiment of the present invention.

FIG. 5 is a drawing showing a transmitter according to an exemplary embodiment of the present invention.

FIG. 6 is a drawing showing a receiver according to an exemplary embodiment of the present invention.

FIG. 7 is a drawing showing a method for radio resource access according to an exemplary embodiment of the present invention.

FIG. 8 is a drawing showing a result of changing a position of a search resource unit according to an exemplary embodiment of the present invention.

FIG. 9 is a drawing showing a result of changing a position of a search resource unit according to another embodiment of the present invention.

FIG. 10 is a drawing showing a case in which a method for resource access according to an exemplary embodiment of the present invention is applied to a PAC ultraframe.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a mobile station (MS) may be referred to as a terminal, a mobile terminal (MT), an advanced mobile station (AMS), a high reliability mobile station (HR-MS), a subscriber station (SS), a portable subscriber station (PSS), an access terminal (AT), user equipment (UE), or the like, and may include all or a portion of functions of MT, MS, AMS, HR-MS, SS, PSS, AT, UE, or the like.

In addition, unless explicitly described to the contrary, the word “comprise” and variations such as “comprises” or “comprising” will be understood to imply the inclusion of stated elements but not the exclusion of any other elements. A term “ . . . part”, “ . . . unit”, “ . . . er”, “module”, “block”, or the like described in the specification means a unit of processing at least one function or operation, and may be implemented by hardware or software or a combination of hardware and software.

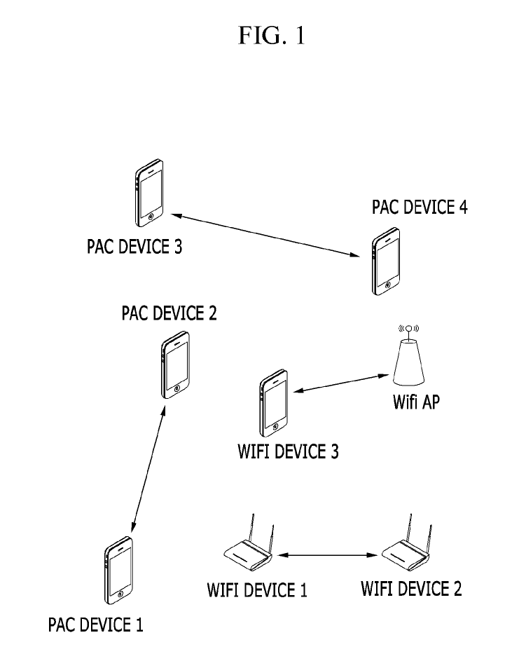

FIG. 1 is a drawing showing a network in which heterogeneous devices are mixed.

Referring to FIG. 1, a peer awareness communication (PAC) device and WiFi device are mixed in the network, and each device may transmit and receive data using an unlicensed band. According to the exemplary embodiment of the present invention, when the PAC device transmits and receives the data using the unlicensed band, a method for radio resource access capable of transmitting/receiving the data without data collision with another heterogeneous device using a carrier sense multiple access (CSMA) scheme will be described.

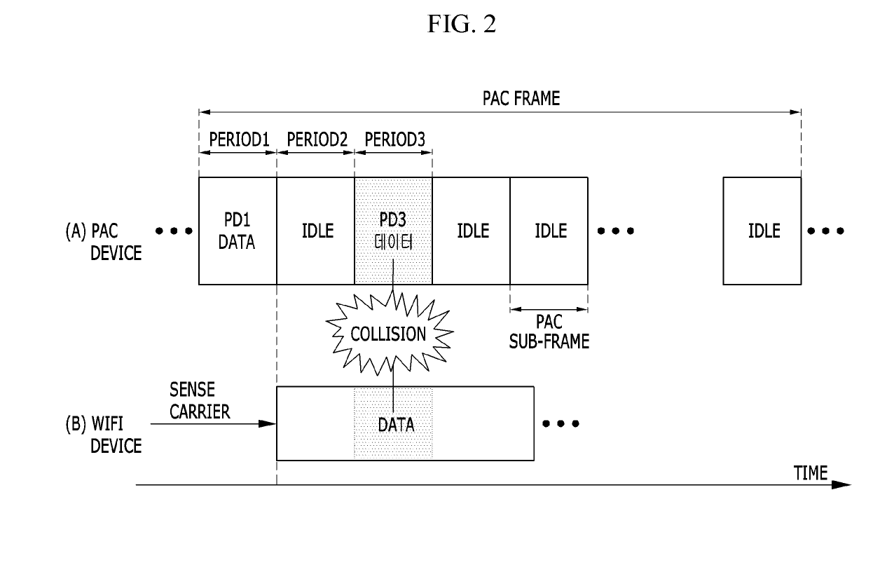

FIGS. 2 (A) and (B) are drawings showing frames transmitted by the PAC device and WiFi device.

FIG. 2 (A) is a PAC frame transmitted by the PAC device, and FIG. 2 (B) is a WiFi frame transmitted by the WiFi device. Referring to FIG. 2 (A), the PAC device transmits the PAC frame having a plurality of sub-frames and transmits the data using a portion of the sub-frames. In FIG. 2 (A), the data are transmitted from a first sub-frame and a third sub-frame.

Referring to FIG. 2 (B), the WiFi device detects a state of a radio resource by sensing a carrier, and when the state of the radio resource is an idle state, the WiFi device transmits the data.

In FIG. 2 (A), when a state of the PAC device becomes the idle state during a second period of a second sub-frame after the first sub-frame is ended, the WiFi device sensing the carrier determines that the radio resource is in the idle state to transmit the data. However, since the PAC device and the WiFi device simultaneously transmit the data during a third period of the third sub-frame, the data collision occurs. A method for preventing the data collision between the heterogeneous devices will be described in an exemplary embodiment of the present invention.

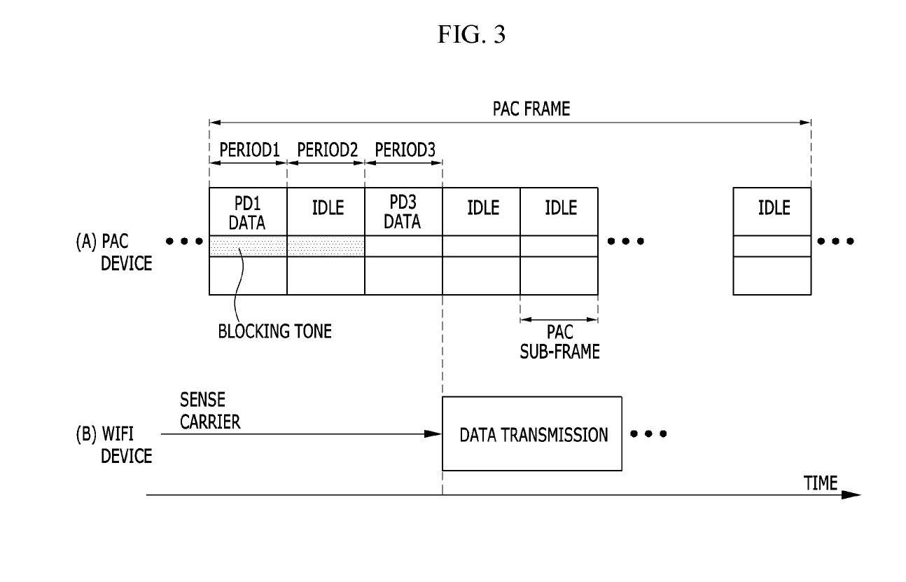

FIGS. 3 (A) and (B) are drawings showing frames transmitted by a PAC device and a WiFi device according to an exemplary embodiment of the present invention.

FIG. 3 (A) shows a PAC frame transmitted by the PAC device and FIG. 2 (B) shows a WiFi frame transmitted by the WiFi device. In FIG. 3 (A), the PAC device may transmit a blocking tone using a partial sub-carrier in the PAC frame. That is, the PAC device transmits the blocking tone from a previous sub-frame of the sub-frame to be transmitted the data, such that another wireless device (WiFi device, etc.) using the CSMA scheme may confirm that the radio resource is in a busy state even in an idle sub-frame of the PAC device by the blocking tone. In this case, the PAC device may continuously transmit the blocking tone even though the sub-frame it occupies is ended for the data transmission of another PAC device.

Referring to FIGS. 3 (A) and (B), a first PAC device transmits the data in a first sub-frame and following a second sub-frame is an idle sub-frame of the PAC devices. Since a third PAC device transmits the data in a third sub-frame, it transmits the blocking tone using the partial sub-carrier from the first sub-frame and the second sub-frame. That is, the third PAC device may transmit the blocking tone from the first sub-frame and the second sub-frame in order to occupy the radio resource up to the third sub-frame. A different kind of device using the CSMA scheme does not use the radio resource of the third sub-frame due to the blocking tone transmitted during a first period and a second period.

FIGS. 3 (A) and (B) describe a case in which the PAC device transmits the blocking tone by way of example, but the exemplary embodiment of the present invention may be applied to all kinds of wireless devices that access the radio resource using the CSMA scheme as well as the PAC device.

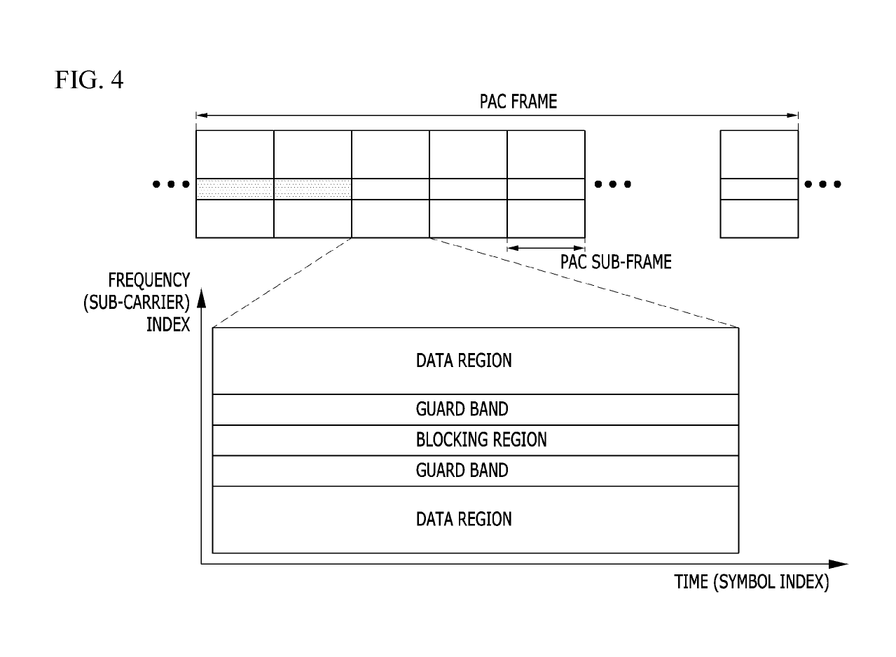

FIG. 4 is a drawing showing a PAC sub-frame according to an exemplary embodiment of the present invention.

Referring to FIG. 4, a single PAC frame includes a plurality of PAC sub-frames. A single PAC sub-frame may include a data region, a guard band, and a blocking region.

The data region is a frequency resource and time used to transmit the data by the PAC device.

The guard band may be inserted between the data region and the blocking region so as to divide the data region and the blocking region. The number of sub-carriers of the guard band may be at least one.

The blocking region is used to prevent access to a resource of a device other than the PAC device. When the blocking region is designed in the PAC sub-frame, an index of the sub-carrier used to transmit the blocking tone may be determined considering interference between the blocking region and the data region of the same band or an adjacent band.

Meanwhile, the number of sub-carriers of the blocking region may be at least one. The number of sub-carriers used to transmit the blocking tone is smaller than the number of sub-carriers of the data region. Accordingly, in order to maintain coverage of a data signal and coverage of a blocking signal to be the same, transmission power strength of the sub-carrier of the blocking tone should be stronger than transmission power strength of the sub-carrier of the data. Here, a difference in average power for each sub-carrier occurs and quantization noise of the data region increases, such that a problem may occur in implementing the transmitter and the receiver.

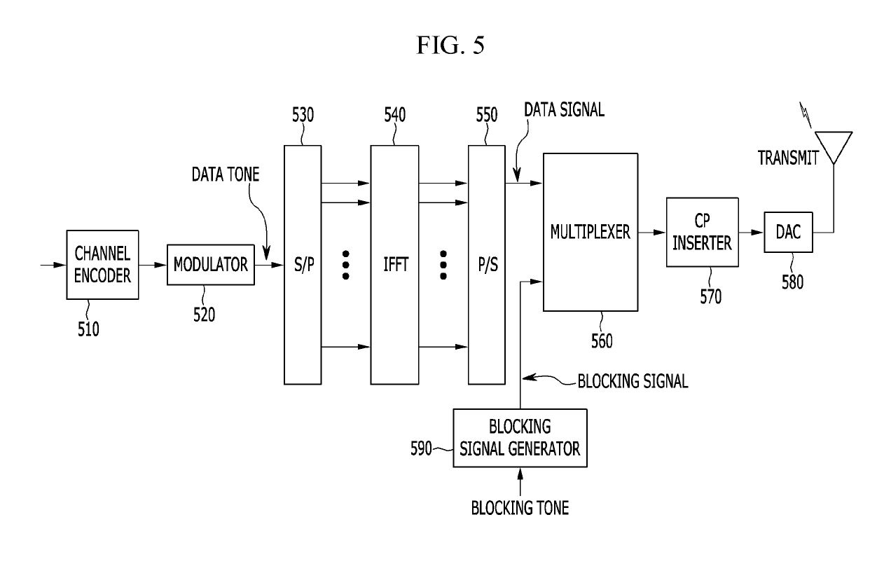

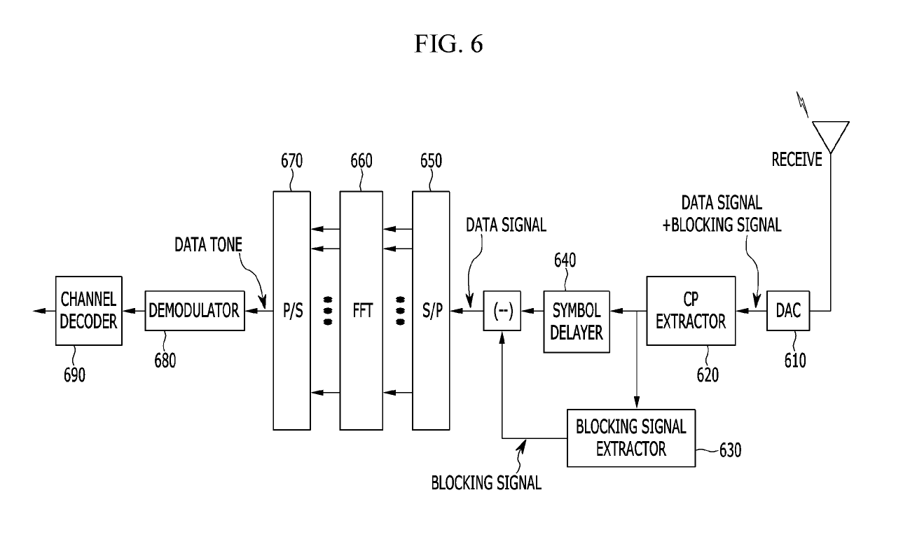

FIG. 5 is a drawing showing a transmitter according to an exemplary embodiment of the present invention, and FIG. 6 is a drawing showing a receiver according to an exemplary embodiment of the present invention.

Referring to FIG. 5, the transmitter generates the blocking signal in a time domain (after IFFT-before DAC) to transmit the generated blocking signal, thereby making it possible to solve the problem that may occur due to the difference in the average power between the sub-carriers in a modulation stage and an inverse fast Fourier transform (IFFT) stage.

First, in the transmitter, a data tone output from a channel encoder 510 and a modulator 520 passes through a serial to parallel (S/P) converter 530, an inverse fast Fourier transform (IFFT) converter 540, and a parallel to serial (P/S) converter 550, and then the data tone is converted into a data signal and is input to a multiplexer (MUX) 560. Here, a blocking signal generator 590 generates the blocking tone into a blocking signal to input the generated blocking signal to the multiplexer. That is, it is possible to multiplex the data signal and the blocking signal in the multiplexer. Then, the multiplexed signal is transmitted through a cyclic prefix (CP) inserter 570 and a digital to analog converter (DAC) 580.

Referring to FIG. 6, the receiver extracts the blocking signal in a time domain (after ADC-before FFT) to remove the blocking signal extracted from the received signal, thereby making it possible to solve the problem that may occur due to the difference in the average power between the sub-carriers in a fast Fourier transform (FFT) state and a data demodulation stage.

First, in the receiver, the received signal is processed in the time domain through an analog to digital converter (ADC) 610 and a cyclic prefix (CP) extractor 620, such that a digital signal in which the CP is extracted is generated. Then, a blocking signal extractor 630 of the receiver extracts a blocking tone from the digital signal to generate the extracted blocking tone into a blocking signal. Here, the extracted blocking signal is a signal that is faded through a radio channel.

Thereafter, a symbol delayer 640 delays the received digital signal, and when the blocking signal is removed from the delayed digital signal, a desired signal may be obtained through a serial to parallel (S/P) converter 650, a fast Fourier transform (FFT) converter 660, a parallel to serial (P/S) converter 670, a demodulator 680, and a channel decoder 690.

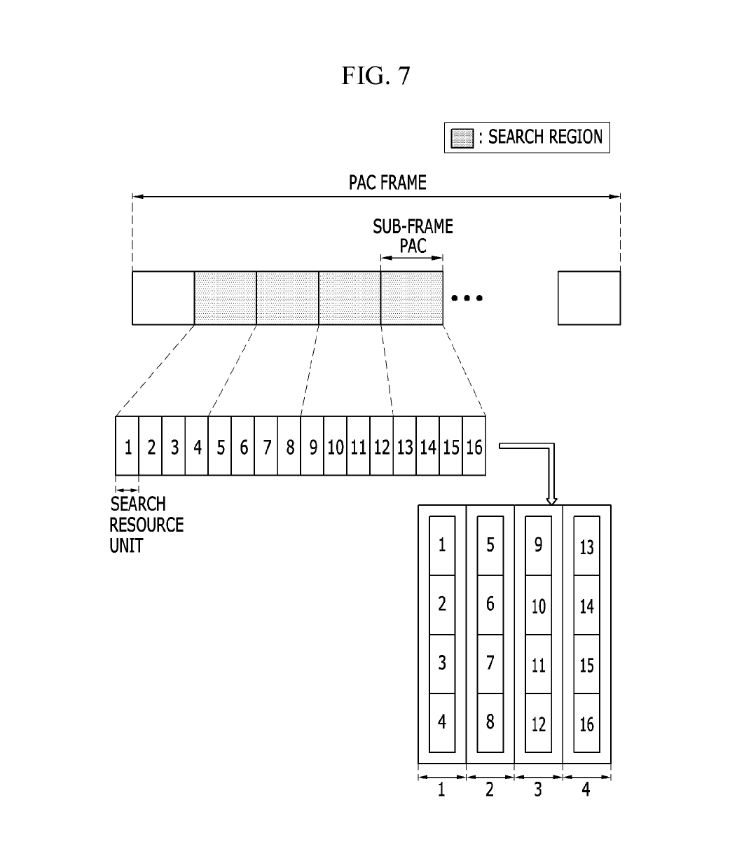

FIG. 7 is a drawing showing a method for a radio resource access according to an exemplary embodiment of the present invention.

The blocking signal according an exemplary embodiment of the present invention is transmitted in a sub-frame unit used for the data transmission of the each PAC device. Since the blocking signal is transmitted in the sub-frame unit, each PAC device may not receive the data transmitted from another PAC device to the sub-frame from which the blocking signal is transmitted. Accordingly, the exemplary embodiment of the present invention changes an order of the PAC device occupying the different radio resources of the same sub-frame per frame.

FIG. 7 shows a method of changing an order of the resource in which the single PAC device occupies a PAC search region. Referring to FIG. 7, the single PAC frame includes a plurality of PAC sub-frames, each single sub-frame is a single blocking resource unit, and each single blocking resource unit includes four search resource units. The each PAC device may transmit search data occupying the single search resource unit.

In FIG. 7, a case in which the blocking signal is transmitted from the search region of the PAC frame will be described by way of example, but the present invention may be applied to all regions of any frame of the wireless device using the CSMA scheme. The number of search resource units included in each single blocking resource unit may be optionally defined.

In FIG. 7, each PAC device may be occupied by selecting the single search resource unit. Therefore, the PAC device transmits the blocking signal from all blocking resource units in which the search resource unit itself is included. For example, the PAC device that selects a 6 search resource unit transmits the search data using the 6 search resource unit and transmits the blocking signal using entire 2 blocking resource unit.

When the blocking signal is transmitted for each of the blocking resource units, the present invention provides a method that may differently set a position of the search resource unit the PAC device occupies so that the single PAC device may receive the data that are transmitted through another search resource unit.

The following Equation 1 represents a method for resource access according the exemplary embodiment of the present invention. When the number of search resource units is n² in an exemplary embodiment of the present invention, the PAC device allows the selected search resource unit to correspond to one of components of an n×n square matrix, and changes the corresponding component to another component of the square matrix, such that the position of the search resource unit in a next frame may be determined. That is, when the position of the search resource unit is represented by the components iₚᵣₑᵥᵢₒᵤₛ and jₚᵣₑᵥᵢₒᵤₛ of the square matrix, the PAC device changes the components iₚᵣₑᵥᵢₒᵤₛ and jₚᵣₑᵥᵢₒᵤₛ of the square matrix corresponding to the search resource unit to other components iₙₑₓₜ and jₙₑₓₜ of the square matrix, such that the search resource unit in the next frame may be determined.

iₙₑₓₜ=iₚᵣₑᵥᵢₒᵤₛ+1, if i+1≦n

iₚᵣₑᵥᵢₒᵤₛ+1−n, if i+1>n (i=1˜n)

jₙₑₓₜ=iₚᵣₑᵥᵢₒᵤₛ+jₚᵣₑᵥᵢₒᵤₛ, if i+j≦n

iₚᵣₑᵥᵢₒᵤₛ+jₚᵣₑᵥᵢₒᵤₛ−n, if i+j>n (j=1˜n) [Equation 1]

In Equation 1, the iₙₑₓₜ and jₙₑₓₜ represent the position in the next frame of each search resource unit. According to Equation 1, the iₙₑₓₜ, which is one of the positions in the next frame of each search resource unit, may be determined as a value that is obtained through circulation augmentation of a number of the iₚᵣₑᵥᵢₒᵤₛ. In addition, the jₙₑₓₜ, which is the other of the positions in the next frame of each search resource unit, may be determined as a sum of the numbers of the iₚᵣₑᵥᵢₒᵤₛ and jₚᵣₑᵥᵢₒᵤₛ.

For example, if the PAC device selects an 11 search resource unit, the 11 search resource unit in a first PAC frame is included in a first sub-frame and corresponds to the components 3 and 3 of the square matrix. The 11 search resource unit in a second PAC frame corresponds to the components 4 and 2 of the square matrix according to Equation 1, and is included in a second sub-frame. Accordingly, since the same sub-frame as the PAC device using the 8, 1, and 14 search resource units is used in the second PAC frame, the PAC device may use the sub-frame different from the PAC device that used the same sub-frame in the first PAC frame. Referring to Equation 1, it can be appreciated that each search resource unit is returned to the same position as the first PAC frame after 2n PAC frames have elapsed.

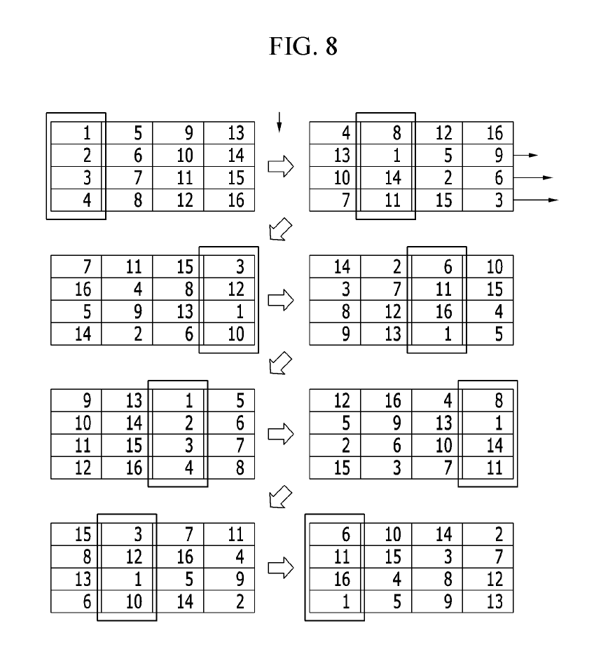

FIG. 8 is a drawing showing a result of changing a position of a search resource unit according to another embodiment of the present invention.

When the 4 search resource units are included in the single blocking resource unit and thus the sixteen search resource units are included in the single PAC search region as shown in FIG. 7, the FIG. 8 shows the position of the search resource unit calculated based on Equation 1.

Each PAC device selects the search resource units of a specific position in the PAC search region of each PAC frame. Thereafter, the PAC device uses the search resource units of another position according to a position changing method for the search resource unit according to the exemplary embodiment of the present invention in the next PAC frame. Meanwhile, although the single PAC device does not receive the data transmitted from another PAC device that selects the search resource units included in the same blocking resource unit, the data transmitted from the other PAC device may be received in the other blocking resource unit in the next PAC frame.

In FIG. 8, the PAC device that selects a first search resource unit among the search resource units of the PAC search region transfers the search data in a first blocking resource unit of the first PAC frame and transmits the blocking signal. Next, the PAC device transfers the search data from a second blocking resource unit in a second PAC frame and transmits the blocking signal. Next, the PAC device transfers the search data from a fourth blocking resource unit in a third PAC frame and transmits the blocking signal.

Equation 2 represents a method for resource access according to another exemplary embodiment of the present invention. When the number of search resource units is n×m in another exemplary embodiment of the present invention, the PAC device allows the selected search resource unit to correspond to one of components of an n×m matrix, and changes the corresponding component to another component of the n×m matrix, such that the position of the search resource unit in the next frame may be determined. That is, when the position of the search resource unit is represented by the components iₚᵣₑᵥᵢₒᵤₛ and jₚᵣₑᵥᵢₒᵤₛ of the n×m matrix, the PAC device changes the components iₚᵣₑᵥᵢₒᵤₛ and jₚᵣₑᵥᵢₒᵤₛ of the n×m matrix corresponding to the search resource unit to other components iₙₑₓₜ and jₙₑₓₜ of the n×m matrix, such that the search resource unit in the next frame may be determined.

iₙₑₓₜ=iₚᵣₑᵥᵢₒᵤₛ+1, if i+1≦n

iₚᵣₑᵥᵢₒᵤₛ+1−n, if i+1>n (i=1˜n)

jₙₑₓₜ=iₚᵣₑᵥᵢₒᵤₛ+jₚᵣₑᵥᵢₒᵤₛ, if i+j≦m

iₚᵣₑᵥᵢₒᵤₛ+jₚᵣₑᵥᵢₒᵤₛ−m, if i+j>m (j=1˜m) [Equation 2]

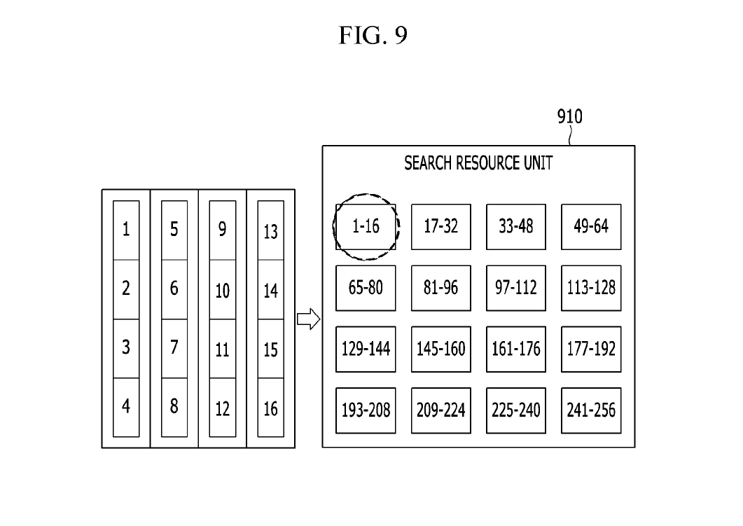

FIG. 9 is a drawing showing a result of changing a position of a search resource unit according to another embodiment of the present invention.

Referring to FIG. 9, the method for the resource access according to the exemplary embodiment of the present invention based on the sixteen search resource units may be applied to a PAC ultraframe 900 in which the number of all search resource units 910 is 256. For example, when the method for the resource access is applied to the 1 to 16 search resource units, the position of the 1 to 16 search resource units of a first PAC ultraframe may be the same as the position of the 1 to 16 search resource units of a ninth PAC ultraframe. That is, the each search resource unit may be returned to the same position as the first PAC ultraframe after 8 (=2n=2×4) PAC ultraframes 900 have elapsed (see FIG. 8).

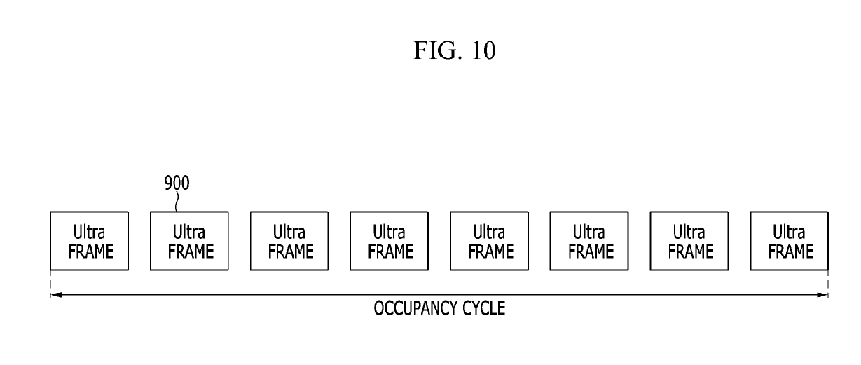

FIG. 10 is a drawing showing a case in which a method for resource access according to an exemplary embodiment of the present invention is applied to a PAC ultraframe.

Referring to FIG. 10, an occupancy cycle that is applied to the search resource unit is the 8 PAC ultraframes 900.

According to the exemplary embodiment of the present invention, each wireless device using the CSMA scheme transmits the blocking signal from the sub-frame transmitting the data to allow the heterogeneous wireless device using the CSMA scheme so as to not occupy the radio resource, thereby making it possible to prevent the data collision.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for resource access of a wireless device, the method comprising:
selecting at least one data sub-frame among a plurality of sub-frames included in a frame;
transmitting the data from the data sub-frame; and
transmitting a blocking signal from a previous sub-frame of the data sub-frame.

2. The method for resource access of claim 1, wherein the transmitting of the blocking signal includes transmitting the blocking signal from all the previous sub-frames of the data sub-frame among the plurality of sub-frames.

3. The method for resource access of claim 1, wherein the transmitting of the blocking signal includes transmitting the blocking signal using at least one sub-carrier.

4. The method for resource access of claim 1, wherein the sub-frame includes a data region in which the data are transmitted and a blocking region in which the blocking signals are transmitted.

5. The method for resource access of claim 4, wherein the sub-frame further includes a guard band so as to divide the data region and the blocking region.

6. The method for resource access of claim 1, wherein the selecting includes selecting the at least one data sub-frame according to a carrier sense multiple access (CSMA) scheme.

7. A method for resource access of a wireless device, comprising:
in a frame including a plurality of sub-frames, selecting a first resource unit among a plurality of resource units included in each of a plurality of sub-frames;
transmitting data from the first resource unit; and
transmitting a blocking signal from a first sub-frame including the first resource unit among a plurality of sub-frames.

8. The method for resource access of claim 7, further comprising:
in next frame of the frame, selecting a second resource unit based on a position at the frame of the first resource unit; and
transmitting the data from the second resource unit.

9. The method for resource access of claim 8, wherein
the selecting of the second resource unit includes:
when the number of the plurality of resource units is n², configuring the first resource unit so as to correspond to a first component among components of an n×n matrix;
determining a position of a second component among the components of the n×n matrix based on the position of the first component; and
determining a position of the second resource unit based on the position of the second component.

10. The method for resource access of claim 9, wherein
the determining of the position of the second component includes
determining a row of the second component through circulation augmentation of a row number of the first component, and
determining a column of the second component in the sum of the row number and the column number of the first component.

11. The method for resource access of claim 9, wherein
in the determining of the position of the second component,
when the position of first component is iₚᵣₑᵥᵢₒᵤₛ and jₚᵣₑᵥᵢₒᵤₛ and the position of the second component is iₙₑₓₜ and jₙₑₓₜ, the position of the second component is determined according to the following equation:
iₙₑₓₜ=iₚᵣₑᵥᵢₒᵤₛ+1, if i+1≦n
iₚᵣₑᵥᵢₒᵤₛ+1−n, if i+1>n (i=1˜n)
jₙₑₓₜ=iₚᵣₑᵥᵢₒᵤₛ+jₚᵣₑᵥᵢₒᵤₛ, if i+j≦n
iₚᵣₑᵥᵢₒᵤₛ+jₚᵣₑᵥᵢₒᵤₛ−n, if i+j>n (j=1˜n)

12. The method for resource access of claim 8, wherein
the selecting of the second resource unit includes,
when the number of the a plurality of resource units is n×m, configuring the first resource unit so as to correspond to a first component among components of an n×m matrix,
determining a position of a second component among the components of the n×m matrix based on the position of the first component, and
determining a position of the second resource unit based on the position of the second component.

13. The method for resource access of claim 12, wherein
the determining of the position of the second component includes
determining a row of the second component through circulation augmentation of a row number of the first component, and
determining a column of the second component in the sum of the row number and the column number of the first component.

14. The method for resource access of claim 12, wherein
in the determining of the position of the second component,
when the position of first component is iₚᵣₑᵥᵢₒᵤₛ and jₚᵣₑᵥᵢₒᵤₛ and the position of the second component is iₙₑₓₜ and jₙₑₓₜ, the position of the second component is determined according to the following equation:
iₙₑₓₜ=iₚᵣₑᵥᵢₒᵤₛ+1, if i+1≦n
iₚᵣₑᵥᵢₒᵤₛ+1−n, if i+1>n (i=1˜n)
jₙₑₓₜ=iₚᵣₑᵥᵢₒᵤₛ+jₚᵣₑᵥᵢₒᵤₛ, if i+j≦m
iₚᵣₑᵥᵢₒᵤₛ+jₚᵣₑᵥᵢₒᵤₛ−m, if i+j>m (j=1˜m)

15. The method for resource access of claim 7, wherein the transmitting of the blocking signal includes transmitting the blocking signal using at least one sub-carrier.

16. The method for resource access of claim 7, wherein the plurality of sub-frames include a data region in which the data are transmitted and a blocking region in which the blocking signals are transmitted.

17. The method for resource access of claim 16, wherein the plurality of sub-frames further include a guard band so as to divide the data region and the blocking region.

18. The method for resource access of claim 7, wherein the selecting includes selecting the first resource unit among the plurality of resource units according to a carrier sense multiple access (CSMA) scheme.
